(19) United States
(12) Patent Application Publication
(10) Pub. No.: US 2008/0220920 A1
(43) Pub. Date: Sep. 11, 2008

(54) Vacuum Generating Dynamic Transmission System, And Associated Methods

(76) Inventor: Gianluca De Pino, Polistena (IT)

Correspondence Address: LATHROP & GAGE LC, 4845 PEARL EAST CIRCLE, SUITE 300, BOULDER, CO, 80301, US

(21) Appl. No.: 12/043,831

(22) Filed: Mar. 6, 2008

Related U.S. Application Data
(60) Provisional application No. 60/893,952, filed on Mar. 9, 2007.

(51) Int. Cl. F16H 7/06; G05B 13/02; F16G 13/02

(52) U.S. Cl. 474/155; 700/28; 59/78.1

(57) ABSTRACT

A vacuum-generating dynamic transmission system includes a first pulley fixed for rotation about a first axle and a second pulley fixed for rotation about a second axle. A chain rotates around the axles and the pulleys. The chain has a plurality of links, one or more of the links having a vacuum-generating device that pressurizes the chain to at least one of the pulleys. The vacuum generating device includes a movable inductor protruding from a central channel on a first side of the link, and a movable abductor within the channel and proximate a second side of the link. The first side of the link contacts a conical semipulley of the first pulley and the second side contacts a cylindrical semipulley of the first pulley, opposite the conical semipulley, as the chain rotates through the pulley. a conduit provides pneumatic communication from the central channel to the outside environment.

### RELATED APPLICATIONS

This application claims priority to U.S. Provisional Application No. 60/893,952, filed Mar. 9, 2007 and incorporated herein by reference.

### BACKGROUND

The majority of modern transmissions work according to a traditional gear system with fixed ratios and a clutch. Whether manual, automatic or sequential, such transmissions generally include the ability to select from several discrete gear ratios or “gears,” for example to slow output speed of the engine and to increase torque (rotational power).

In contrast with other mechanical transmissions, increasingly popular continuously variable transmissions (“CVTs”) provide an essentially infinite number of gear ratios within the range from the lowest to the highest gear. Generally speaking, a CVT is a transmission in which the ratio of the rotational speeds of two shafts (e.g., the input and output shafts of a vehicle or other machine) can be varied continuously within a given range. CVTs therefore allow a greater selection in the relationship between the speed at which a vehicle is driven (e.g., wheel speed) and the speed of the vehicle's engine. This greater selection can increase fuel economy by enabling the engine to run at its most efficient speeds within the aforementioned range.

Despite their benefits, CVTs suffer substantial drawbacks. Belt or chain driven systems, which presently make up the majority of market-available CVTs, can waste significant energy through slippage of twisting surfaces. For example, CVTs such as the variable diameter pulley (VDP) and the roller-based CVT may lose efficiency due to slippage of a chain or belt against a pulley (the VDP), or a roller against a conical part (the roller-based CVT). These systems are likewise subject to high component wear. See also Simkin's Ratcheting CVT, described in U.S. Pat. No. 5,516,132, and Anderson's A+CVT, described in U.S. Pat. Nos. 6,575,856 and 6,955,620.

Torque handling capability of the above CVTs may also be limited by their capacity to withstand friction wear between torque source and transmission medium. These CVTs are therefore typically limited to low powered cars and other light duty applications. For example, the majority of CVTs are not meant to perform under torque requirements greater than 300 Nm, in a 190 HP engine. CVTs likewise suffer a substantial decrease in performance at high and low revolutions, and are not generally employed for moving heavy loads. Further, contemporary CVTs generally do not adapt their performances to real-time variation in encountered forces.

### SUMMARY

The vacuum generating dynamic transmission system disclosed herein may overcome problems associated with contemporary mechanical transmissions and CVTs, to provide a reduced friction and increased performance transmission, thereby enhancing engine performance and prolonging engine life. The disclosed vacuum generating transmission system allows for changing gear ratios between engine revolutions and the revolutions of a rotating object, by varying the pulley diameter around which the chain or belt runs. A device within the chain eliminates skidding or sliding of the chain or belt, thus reducing component wear and energy consumption, e.g., by permitting an engine to operate efficiently under high power, load or speed. The disclosed vacuum generating dynamic transmission system allows grip factor to be calculated and set to match the level of power or resistance encountered or desired, for example by pressurizing the entire system using external agents such as a pump.

As used herein, the term “chain” may refer to a metal, plastic or rubber chain or belt. Those of skill, for example, in the automotive arts will recognize that other materials used in chains or belts (e.g., in drive chains) may also be applied with the chain described herein.

In one embodiment, a vacuum-generating dynamic transmission system includes a first pulley fixed for rotation about a first axle and a second pulley fixed for rotation about a second axle. A chain for rotation around the axles and the pulleys has a plurality of links. One or more links of said plurality has a vacuum-generating device that pressurizes the chain to at least one of the pulleys.

In one embodiment, a method for forcing a drive chain against pulleys of a continuously variable transmission includes, in response to contact between the pulleys and chain, moving an inductor and abductor within one or more chain links of the chain to create a vacuum that forces the chain to the pulleys.

In one embodiment, a method for vacuum-generating, dynamic transmission includes providing a system of pulleys. Each pulley of the system has a conical semipulley and a cylindrical semipulley joined by an axle. A chain is provided, for rotation around the pulleys. The chain has at least one vacuum-generating link for forming a vacuum seal with the cylindrical semipulleys when the link rotates through the pulleys. At least a first conical semipulley is moved along its respective axle in a first direction and by a first distance, to vary the rotational diameter of the chain. A second conical semipulley is moved along its respective axle by the first distance, in a second direction opposite the first direction, to maintain tension of the chain.

In one embodiment, a vacuum generating chain for a continuously variable transmission has a plurality of chain links. One or more of the chain links includes at least one vacuum-generating device that pressurizes the chain to at least one pulley of the continuously variable transmission.

In one embodiment, a vacuum-generating dynamic transmission system includes a housing; at least two pulleys fixed upon axles and disposed within the housing, and a vacuum-generating chain for rotation around the axles and the pulleys. The chain has trapezoidal shaped links. One or more of the links includes a vacuum generating device. At least one pressure sensor senses pressure within the housing. A processor is in communication with the pressure sensor and a pressure regulating device. The processor engages the pressure regulating device to adjust pressure within the housing, responsive to pressure information from the pressure sensor and power requirements of an engine in communication with the vacuum-generating transmission system.

In one embodiment, a vacuum generating dynamic transmission system as described herein further includes a link for connection to an external mechanical, electronic, pneumatic or hydraulic device for assisting movement of one or more components of the system.

### BRIEF DESCRIPTION OF THE DRAWINGS

The following Figures are illustrative, and should not be interpreted in a limiting sense. For example, the Figures may not be drawn to scale.

FIG. 1 depicts one embodiment of a vacuum generating dynamic transmission system.

FIG. 2 is an exploded view showing the system of FIG. 1, rotated 90° clockwise.

FIGS. 3A and 3B are cross-sectional views of an axle, pulley and chain of the system of FIGS. 1 and 2, illustrating chain position relative to pulley width.

FIG. 4A is a side view illustrating one gear ratio configuration of the system of FIGS. 1 and 2.

FIG. 4B is a top view showing the gear ratio configuration of FIG. 4A.

FIG. 5A is a side view illustrating one gear ratio configuration of the system of FIGS. 1 and 2.

FIG. 5B is a top view showing the gear ratio configuration of FIG. 5A.

FIG. 6 is a perspective view illustrating a section of chain and internal components of one chain link, entering a pulley of the system of FIGS. 1 and 2.

FIG. 7A is a perspective view of the chain link and internal components shown in FIG. 6.

FIG. 7B is another perspective view of the chain link and internal components of FIG. 7A.

FIG. 7C is another perspective view of the chain link and internal components of FIGS. 7A and 7B.

FIG. 8 is an exploded view of the chain link and internal components of FIGS. 7A-C.

FIG. 9 is a modified cross-sectional view of the chain link and components shown in FIGS. 7A-8.

FIG. 10 is a modified cross-sectional view of the chain link of FIGS. 7A-9 partially between two semipulleys, showing details of an internal vacuum-generating device.

FIGS. 11A-E illustrate motion of components of the vacuum-generating device of FIG. 10, as the chain link travels through a pulley.

FIG. 12 is a perspective view of a vacuum-generating dynamic transmission system with dual conical pulleys and dual vacuum-generating chains.

FIG. 13 schematically shows a vacuum-generating transmission system in a pressurizable housing.

FIG. 14A is a schematic side view of a vacuum generating dynamic transmission system with chain link and vacuum generating device, according to an embodiment.

FIG. 14B is a side view position diagram illustrating position of the link of FIG. 14A, as the link rotates between semipulleys.

FIG. 14C is a top view position diagram illustrating position of the link of FIG. 14A, as the link rotates between semipulleys.

FIG. 15A is a simplified side-view diagram, separately detailing the vacuum generating device and link of FIG. 14A.

FIG. 15B is a simplified side view showing the vacuum generating device and link of FIG. 14A, together.

FIG. 16A is a perspective view showing additional detail of the link and vacuum generating device as depicted in FIG. 15B.

FIG. 16B is a perspective view showing further detail of the link of FIG. 14A.

FIG. 16C is an exploded perspective view showing the link and vacuum generating device of FIGS. 15A-16B.

FIG. 17A is a schematic front view of the link and vacuum generating device of FIG. 14A.

FIG. 17B is a simplified side view of the link and vacuum generating device of FIG. 14A.

FIG. 17C is a simplified rear view of the link shown in FIG. 14A.

FIG. 18 is a schematic diagram showing a plurality of joined links (as in FIGS. 17A-17C) rotating about an axle.

FIG. 19 is a schematic side view depicting a vacuum generating device, chain link and other components of a vacuum generating dynamic transmission system, in accordance with an embodiment.

FIG. 20 shows the vacuum generating device and chain link of FIG. 19, assembled together.

FIG. 21A is an inductor-side perspective view of the link of FIG. 19.

FIG. 21B is an abductor-side perspective views of the link of FIG. 19.

FIG. 21C is an exploded perspective view of the vacuum generating device and link of FIG. 19.

FIGS. 22 and 23 are simplified cross-sectional diagrams of the vacuum generating device and link of FIG. 19 between semipulleys, showing movement device components due to pressure changes.

FIG. 24A is a schematic front view of the link and vacuum generating device of FIG. 19.

FIG. 24B is a simplified side view of the link and vacuum generating device of FIG. 19.

FIG. 24C is a simplified rear view of the link shown in FIG. 19.

FIG. 25 is a schematic diagram showing a plurality of joined links (as in FIG. 19) rotating about an axle.

### DETAILED DESCRIPTION

It is appreciated that the present teaching is by way of example, not limitation. The illustrations herein are not limited to use or application with a specific type of transmission. Thus, although the instrumentalities described herein are for the convenience of explanation, shown and described with respect to exemplary embodiments, it is appreciated that the principals herein may be equally applied in other embodiments of transmissions. Further detail and examples of the disclosed vacuum generating dynamic transmission system are included with attached Appendix A, which forms a part of this disclosure.

For ease of discussion, vacuum-generating dynamic transmission system 100 is described herein below with respect to a generic engine; however, those skilled in the art will recognize, after reading and fully appreciating the present disclosure, that system 100 may be applied with any vehicle (including bicycles, automobiles, aircraft and watercraft) or machine having a transmission.

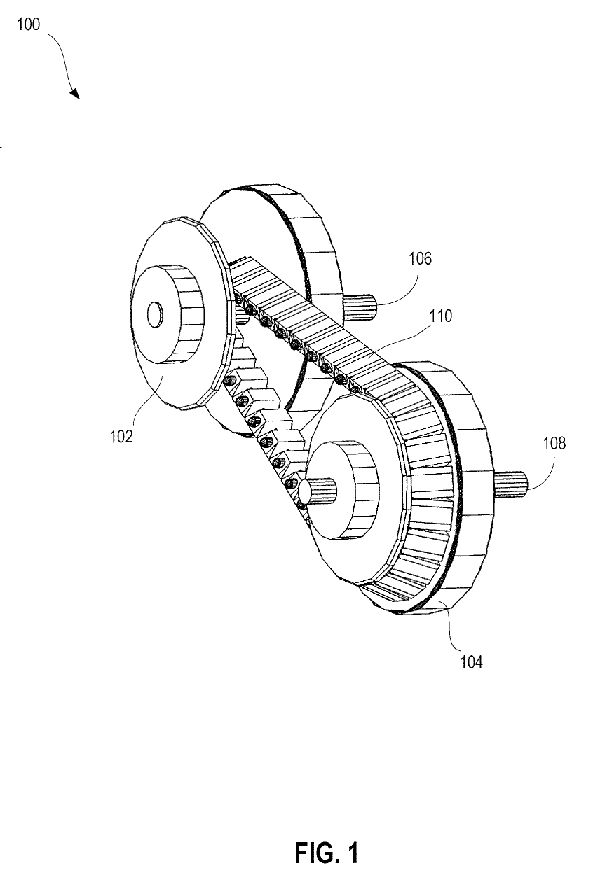

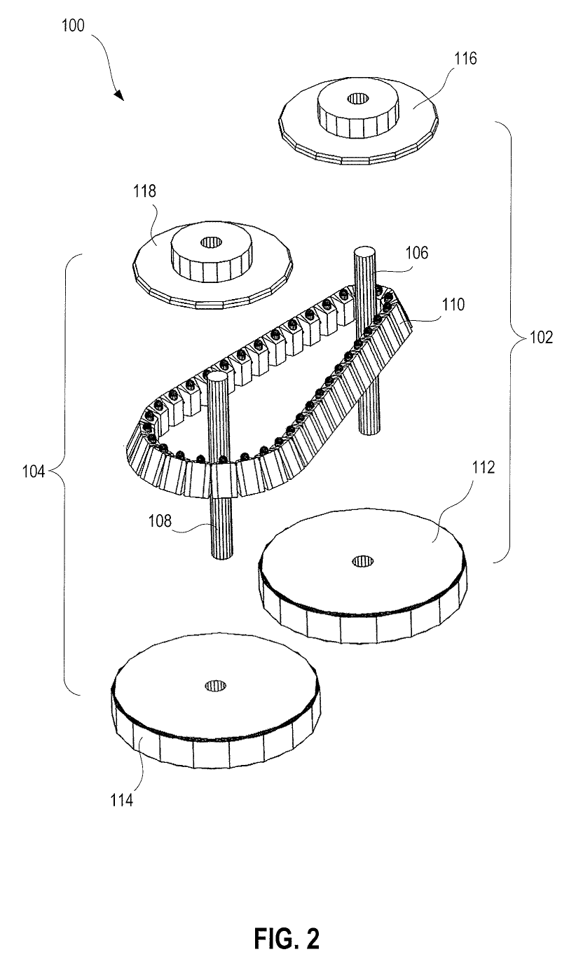

FIGS. 1 and 2 show one embodiment of a vacuum generating dynamic transmission system 100. System 100 includes pulleys 102, 104 mounted on respective axles 106, 108. A chain or belt 110 revolves around pulleys 102, 104 on axles 106, 108. As shown in FIG. 2, pulley 102 includes cylindrical semipulley 112 and conical semipulley 116, and pulley 104 includes cylindrical semipulley 114 and conical semipulley 118.

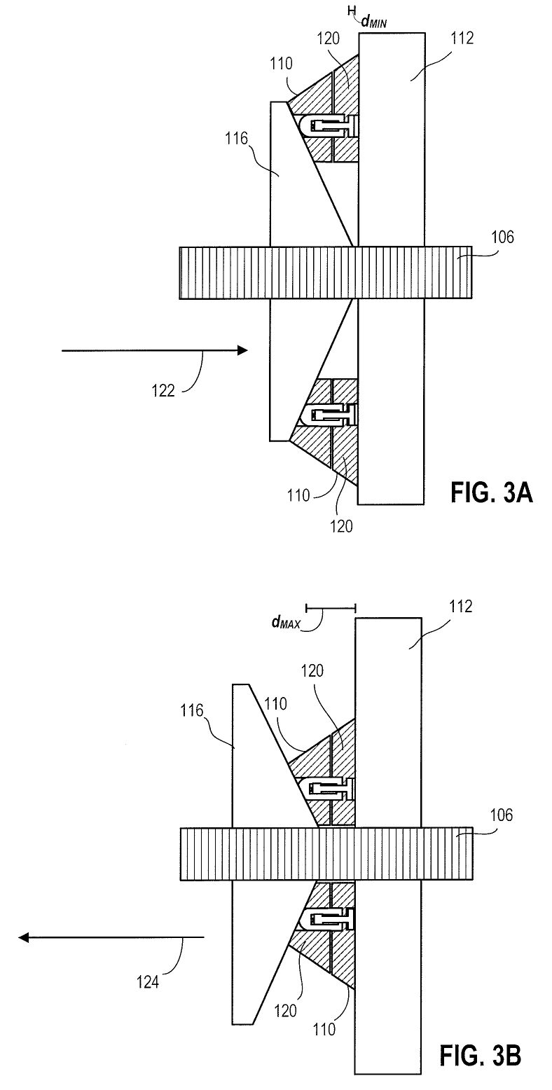

FIGS. 3A and 3B are modified cross-sectional views of semipulleys 112, 116 and chain 110, along rotation axle 106. In one embodiment, the position of cylindrical semipulley 112 on axle 106 is fixed, while conical semipulley 116 may move in and out along axle 106, as shown by motion arrows 122, 124 in FIGS. 3A and 3B, respectively. The shape of chain 110 may vary according to design preferences. In one aspect, chain 110 has trapezoidal chain links 120, which allow chain 110 to slide inward, toward axle 106, as conical semipulley 116 moves away from cylindrical semipulley 112, as indicated by motion arrow 124. In other words, links 120 automatically position at a lowest point (i.e., a point closest to axle 106) when conical semipulley 116 travels to its maximum distance d_{MAX} from semipulley 116, when semipulleys 112, 116 move apart along axle 106. Links 120 automatically position proximate a point farthest from axle 106 when cylindrical and conical semipulleys 112, 116 are separated by their minimum distance, d_{MIN} (moving together along axle 106). Semipulley 112 for example moves in and out along axle 106 to maintain compression against chain 110, and thus “sets” the diameter over which chain 110 revolves. Thus, by varying the distance between semipulleys 112, 116 and 114, 118 (e.g., by shifting conical semipulleys 116, 118 along rotation axles 106, 108) the diameter on which chain 110 runs may be varied to provide an essentially infinite continuum of gear ratios within the range of semipulley motion. Semipulleys 116, 118 may be positioned throughout their range of motion manually or electronically, for example via mechanical, hydraulic, pneumatic and/or centrifugal force.

When a load is imparted upon transmission system 100 (e.g., when the transmission is linked with an object to be rotated), motion of semipulleys 116, 118 and the trapezoidal shape of chain 110 aid system 100 in automatically assuming a configuration corresponding to the optimal gear ratio for the power requirements upon system 100. In order to maintain chain tension and length, movement of semipulleys 116 and 118 are related in inverse proportion to one another. In one embodiment, if semipulley 116 moves away from semipulley 112, semipulley 118 moves towards semipulley 114, in accordance with the diameter around which chain 110 revolves at a given moment. Semipulleys 116, 118 are synchronized such that opening of semipulley 116 along axle 106 (e.g., in the direction of arrow 124) by a distance D corresponds with the closing of semipulley 118 along axle 108 by distance inversely related to D. Relative movement of pulleys 102, 104 for example relates nonlinearly to the rotational diameter. That is, pulley movement may increase as rotational diameter decreases, and pulley movement may decrease as rotational diameter increases.

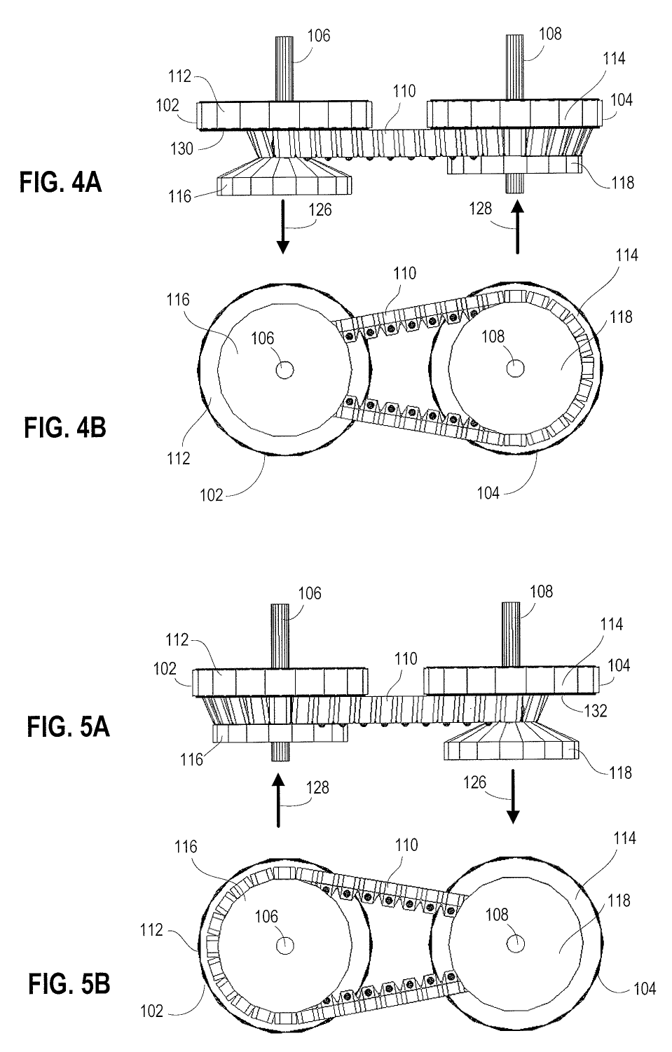

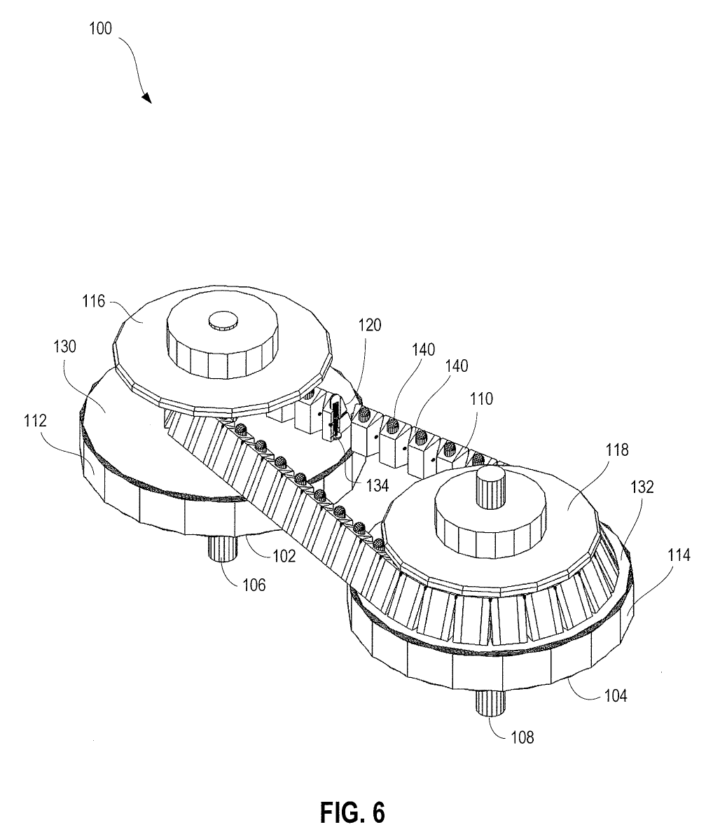

Relative movement/position of semipulleys 116, 118 is illustrated in FIGS. 4A-5B. As shown in FIGS. 4A-B, when semipulley 116 moves outward and away from semipulley 112, e.g., along axle 106 in the direction of arrow 126, semipulley 118 moves inward, e.g., along axle 108 as indicated by arrow 128. Chain 110 for example revolves around or near d_{MIN} of semipulley 116 and around or near d_{MAX} of semipulley 118 (see FIGS. 3A-B). On the other hand, as semipulley 116 moves inward along axle 106 in the direction of arrow 128, semipulley 118 moves outward along axle 110 in the direction of arrow 126 (see FIGS. 5A-B). Trapezoidal chain 110 automatically adjusts to a position of least friction along the side of conical semipulleys 116, 118, thus dropping into place proximate d_{MAX}of semipulley 116 and rotating around semipulley 118 proximate d_{MIN}. As described below with respect to FIGS. 6-11D, rotation of pulleys 102, 104 initiates vacuum capabilities of chain 110, to secure the chain against inner faces 130, 132 of respective cylindrical semipulleys 112, 114. Systems and methods disclosed hereinafter are described in relation to a chain 110. However, it will be understood that vacuum-generating characteristics may likewise be provided in a similarly shaped belt incorporating the vacuum-generating device described now with respect to FIG. 6.

FIG. 6 is a perspective view of system 100, showing detail of chain link 120. Link 120 includes an anti-skid or vacuum-generating device 134. When link 120 contacts pulley 102 or 104, vacuum-generating device 134 creates a vacuum between link 120 and inner face 130 or 132 of semipulley 112 or 114, respectively (see FIGS. 4A and 5A). The vacuum forces or pressurizes chain 120 to inner pulley face 130 or 132 to prevent slipping or skidding. In one embodiment, the vacuum force generated by chain 110 on face 130 and/or 132 is of a constant value; however, the force may be altered by further pressurizing entire transmission system 110. System 100 may for example be housed within an airtight or pressurized chamber. A computer may control the airtight or pressurized chamber, for example according to input from sensors in communication with the chamber, to pressurize the entire system 100 as a function of power or resistance encountered.

Vacuum forces between chain 110 (e.g., lines 120) and pulley faces 130, 132 may be augmented (e.g., via the aforementioned computer and sensors) according to force (Horsepower) input or load requirements. For example, a loaded truck running on a flat surface at full power requires the highest effort when it starts moving. As the truck's speed increases, the resistance that the truck encounters diminishes. Under control of the computer, system 100 provides greater pressure when the truck starts moving, in accordance with the increased force required to move the truck. Vacuum-generating device 134 of system 100 (described in greater detail below) prevents chain slippage in the increased pressure conditions. As the truck speeds up and the encountered resistance lessens, the computer accordingly and progressively decreases the pressure of system 100, thus reducing grip factor and enhancing smooth transition between gear ratios. On the other hand, system 100 may also provide resistance when force from the truck engine becomes negative, for example, aiding in braking. System 100 thus provides a marked improvement to existing CVTs, which may require an additional adjustement system so that the CVT can operate within its limited range of performance.

Although FIG. 6 shows inductors 140 (explained below) on each link 120, it will be appreciated that the number of links 120 having a vacuum-generating device 134 may be varied according to desired application. For example, every other link 120 of a chain 110 may include a vacuum-generating device 134. Likewise, chain 110 may be manufactured to correspond with a variety of pulley and/or axle sizes, with consideration given to the number of links in contact with the pulley during rotation. Hence, chain 110 may be manufactured with vacuum-generating devices spaced such that one, two or any other desired number of vacuum-generating links contact the pulley surface at any given moment during chain rotation. For example, where greater skid or slip prevention is required, a greater number (e.g., all) of the links may include a vacuum-generating device 134. In applications where skid or slip is a lesser concern, chain 110 may be manufactured with fewer vacuum-generating devices.

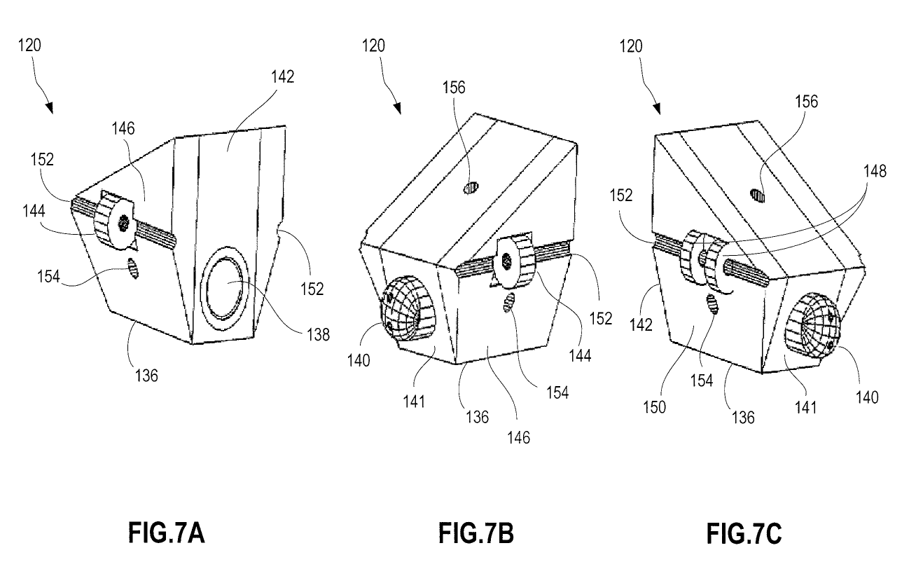

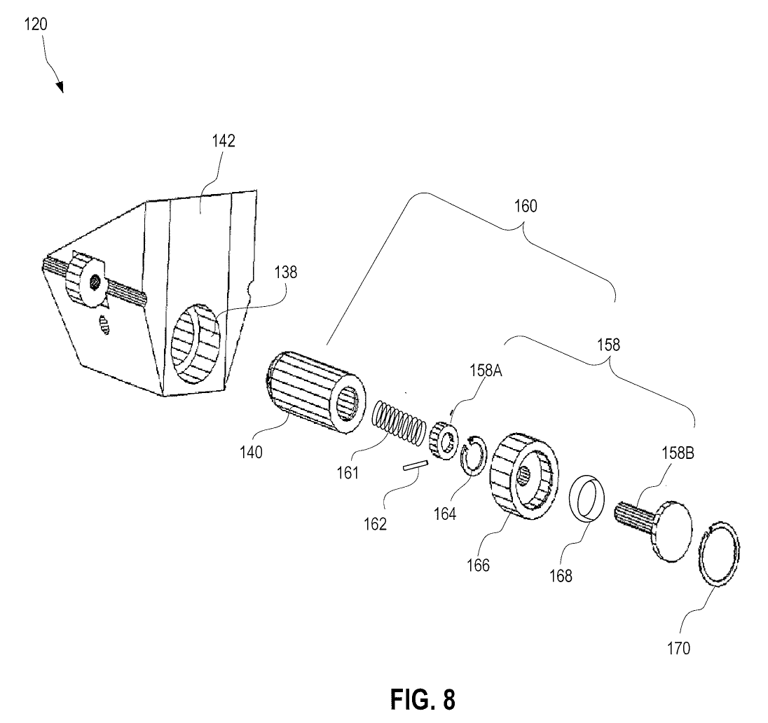

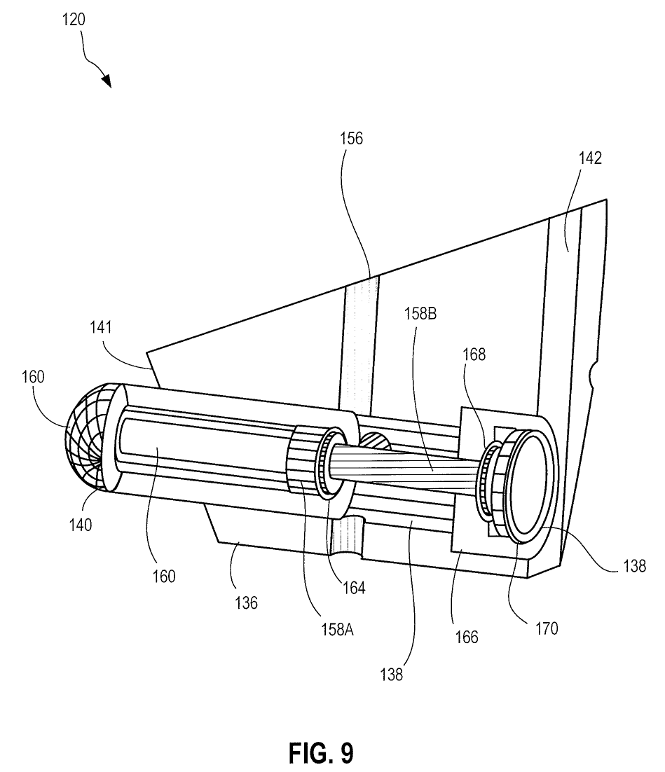

Further detail of link 120 is shown in perspective view FIGS. 7A-C. A link body 136 includes a central channel 138 for accommodating components of vacuum-generating device 134, including an inductor 140 (FIG. 7B), and for facilitating pressurization within link 120. Chain link 120 has an inductor face, proximate an inductor side of the chain link, and an abductor face, proximate an abductor side of the chain link, when vacuum generating device 134 is assembled within link 120. As shown in FIGS. 7A-C, inductor 140 protrudes from inductor face 141 of chain link 120. Central channel 138 is shown opening onto abductor face 142. Abductor face 142 contacts cylindrical semipulley 112/114 (e.g., along inner face 130) when chain 110 rotates through pulleys 102/104. A middle roller 144 on joining side 146 of link 120 fits with lateral rollers 148 positioned on joining side 150 of a second link 120 (see FIG. 7C). Pin channels 152 allow for securing links 120 together via linking pins (not shown). Channel 154 may be used to secure components of vacuum-generating device 134 within central channel 138, e.g., using a screw, cotter pin or other fastener. A conduit 156 provides pneumatic communication between the outside and the inside (e.g., central channel 138) of each link 120. As explained further with respect to FIGS. 8 and 9, movement of inductor 140 within central channel 138 shuts conduit 156, creating a pressurized chamber within vacuum-generating device 134. Conduit 156 is for example closed as chain 110 rotates around pulley 102 or 104, and contact with conical semipulley 116 or 118 pushes inductor 140 into link body 136. See, e.g., FIG. 6.

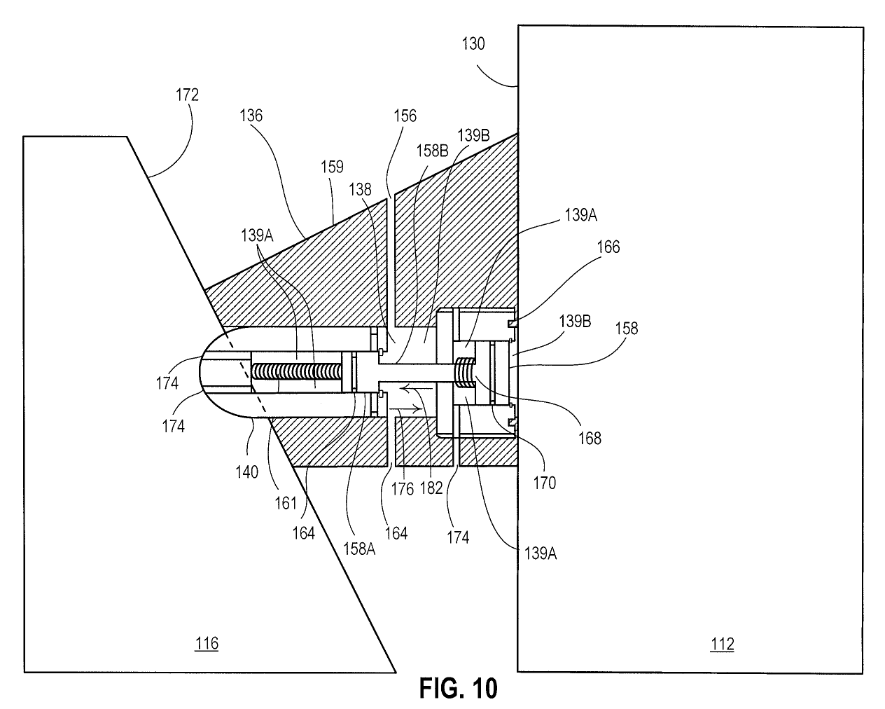

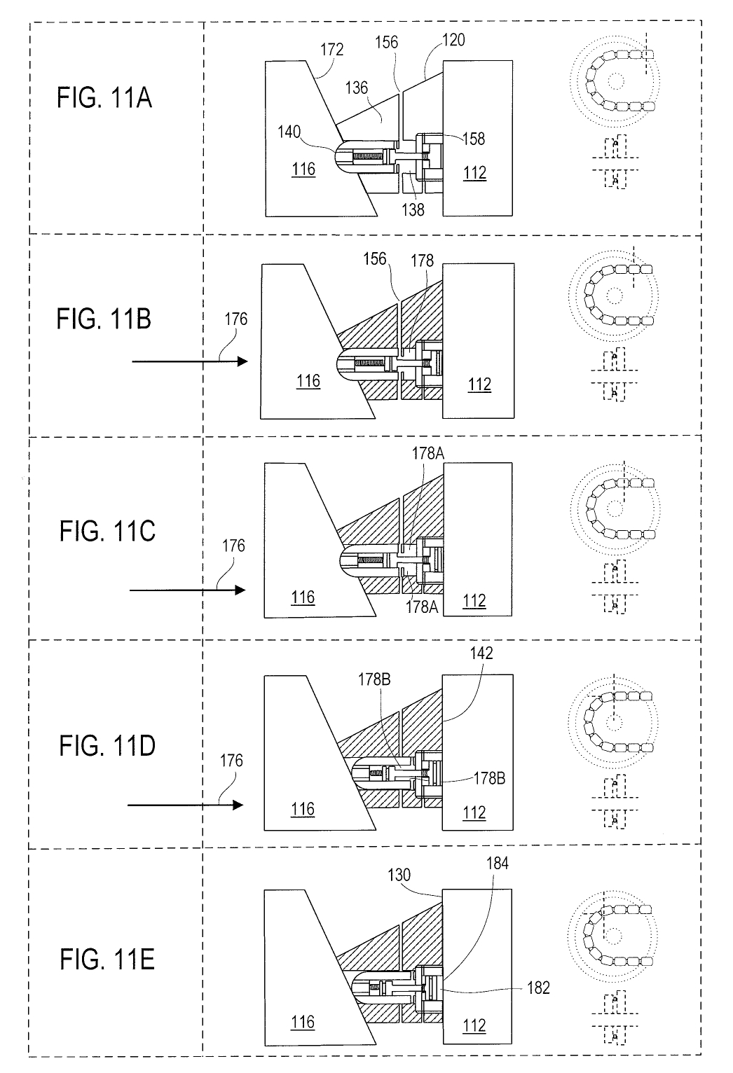

Turning to FIG. 8, Vacuum-generating device 134 includes inductor 140 and abductor components 158A and 158B (collectively, abductor 158). Abductor 158 includes or forms a piston 159, shown in FIG. 10. Inductor 140 and abductor 158 (which may be collectively referred to hereinafter as actuator 160) respond to contact with one or both of pulleys 102, 104 to provide pressurization within the channel. Inductor 140 and abductor 158 are for example cylindrical components sized to fit respectively within central channel 138 and within inductor 140. A spring 161 fits within inductor 140 to return actuator 160 to a non-compressed ready position, for example when link 120 is between pulleys 102 and 104, and thus inductor 140 is not compressed by contact with conical semipulleys 116 and 118. Compression of inductor 140 by conical semipulleys 116, 118 is explained further with respect to FIGS. 10 and 11A-E, below.

Abductor components 158A and 158B are joined by a plug 162. Plug 162 is for example a cylindrical tempered plug that fixes components 158A and 158B together. A safety ring 164 fits between abductor component 158A and a locking screw 166, for holding actuator 160 in place within central channel 138. Safety ring 164 may be elastic, plastic or another resilient material. A second spring 168 fits within screw 166, to aid in returning actuator 160 to its ready position. A second safety ring 170, which may also be elastic or another resilient material, fits with central channel 138. Safety rings 164, 170 support inductor and abductor components 140, 158. In one embodiment, rings 164, 170 improve pressure ratios of inductor and abductor components 140, 158.

FIG. 9 is a cross-sectional view through chain link 120, showing actuator 160 assembled within central channel 138. FIG. 10 is a similar, schematic cross-sectional view depicting link 120 partially between cylindrical and conical pulley components. Inductor 140 is illustratively shown in an extended position that for example corresponds to the position of chain link 120 before (or after) inductor 140 is compressed by contacting semipulley 116. Link 120 is illustratively shown between cylindrical semipulley 112 and conical semipulley 116; however, it will be understood that link 120 could equally be shown with semipulleys 114, 118. In FIG. 10, link 120 is held partially between semipulleys 112, 116. It will be understood that if link 120 advances between the semipulleys (e.g., moving into the page), Actuator 160/inductor 140 contacts and is compressed by an inner face 172 of conical semipulley 116. For example, inductor 140 is pressed into central channel 138 of link body 136 by inner face 172. Also shown in FIG. 10 are inductor and abductor release holes 174.

In one embodiment, release holes 174 normalize pressure within different areas of one or more chambers 178 (see FIGS. 11A-E) as inductor 140 is pressed into channel 138. For example, release holes 174 provide conduits for air to re-enter chamber or chambers 178 as chain link 120 moves progressively out of pulley 102 or 104. Air is pushed out through release holes 174 as the chain link enters the pulleys (e.g., to equalize pressure in different areas of chamber 178 surrounding actuator 160) and sucked in as the chain link exits the pulleys. Release holes 174 for example prevent areas 139A from becoming over pressurized and counteracting the force created by pressure within channel 138, which pushes the abductor away from inner face 130 of cylindrical semipulley 112. Hence, release holes 174 facilitate preservation of a vacuum created within areas 139B, and further prevent pressure within chain link 120 from counteracting a vacuum effect between chain link 120 and semipulley 112. Creation of the vacuum is further described below with respect to FIGS. 11A-E.

FIGS. 11A-E are cross-sectional views of link 120, illustrating generation of vacuum forces for securing link 120 to a cylindrical semipulley as chain 110 passes through pulley 102 or 104. Pulley 102 and semipulleys 112, 116 are shown; however, movement of chain 110 through pulley 104 (semipulleys 114, 118) may likewise be explained by FIGS. 11A-E.

As chain 110 winds around axle 106 (not visible), link 120 is drawn toward pulley 102 (FIG. 11A). As link 120 enters pulley 102, inductor 140 contacts inner face 172 of conical semipulley 112, and is pushed into central channel 138 of link body 136, as indicated by motion arrow 176 (FIG. 11B). Movement of inductor 140 into central channel 138 closes conduit 156, creating pressurized chamber or chambers 178 (FIG. 11C) within link 120. Movement of inductor 140 further into link body 136 (e.g., as chain 110 rotates further around axle 106) reduces the size of chamber or chambers 178, increasing chamber pressure as the volume of air within chamber or chambers 178 is compressed into a smaller area (compare chambers 178A, FIG. 11C with chambers 178B, FIG. 11D). Chambers 178B for example have a total area that is less than the area of chambers 178A; therefore, the overall pressure value of chamber 178 increases (i.e., is multiplied) as inductor 140 moves further into link body 136. As shown in FIG. 11. Pressure at chamber or chambers 178 (e.g., at 178B) forces abductor 158 (e.g., piston 159/element 158A) to be pulled in a direction (indicated by arrow 182) that is opposite the direction of inductor 140 movement (see arrow 176). For example, abductor 158 moves inward and away from inner face 172. Release holes 174 permit escape of pressure from chamber 178 (e.g., from areas 139A) to facilitate inward motion of abductor 158. As shown in FIG. 11E, inward motion of abductor 158 creates a vacuum 184 between inner face 130 of cylindrical semipulley 112 and abductor face 142 of link 120. Vacuum 184 for example creates a virtual crown or pinion, securing the chain/chain link along any diameter of pulley 102 as it rotates (e.g., at any available position on semipulley 112, see description of FIGS. 3A and 3B, above). Vacuum-generating device 134 thereby prevents sliding or skidding, regardless of rotational diameter. As noted above, the rotational diameter is determined by motion of conical semipulley 116 in and out along axle 106 (or semipulley 118 along axle 108). Through their motion, conical semipulleys 116, 118 may thereby determine diametric position of rotation of chain 110, maintain fixed chain tension and set vacuum-generating device 134.

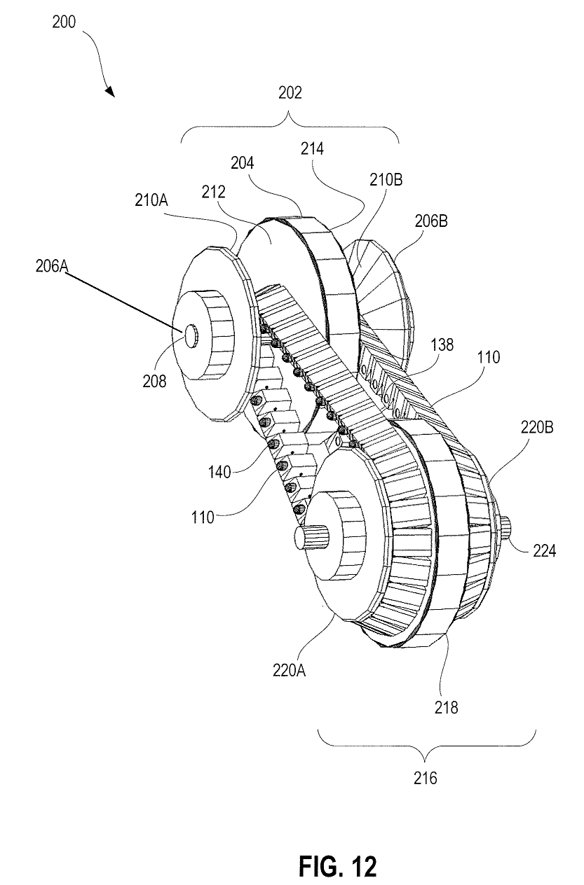

FIG. 12 shows a vacuum generating dynamic transmission system 200, employing dual vacuum-generating chains 110. Pulley 202 has one cylindrical semipulley 204 and two conical semipulleys 206A, 206B, one positioned on each side of cylindrical semipulley 204. Semipulleys 204, 206A, 206B rotate around axle 208. Inductors 140 of chains 110 contact and are pressed into link bodies 136 by sloping inner faces 210A and 210B of conical semipulleys 206A, 206B. Vacuum forces generated between chain links 120 and faces 212, 214 of cylindrical semipulley 204 create a virtual pinion and secure chains 110 to cylindrical semipulley 204, regardless of the rotational diameters set by conical semipulleys 206A, 206B.

Pulley 216 includes cylindrical semipulley 218 and two conical semipulleys 220A, 220B, mounted on rotational axle 224. As explained with respect to pulley 202, as chains 110 contact pulley 216, sloping inner surfaces of conical semipulleys 220A, 220B activate vacuum-generating devices 134 within links 120, securing chains 110 to cylindrical semipulley 218, regardless of rotational diameter. The diameter of rotation between cylindrical semipulley 218 and conical semipulley 220A is for example inversely proportional to the rotational diameter at pulley 202 (i.e., between conical semipulley 206A and cylindrical semipulley 204), to aid in maintaining chain tension and length. Likewise, as conical semipulley 206B opens or moves along axle 208 away from cylindrical semipulley 204, conical semipulley 220B closes, or moves along an axle 224 towards cylindrical semipulley 218. In adding second conical semipulleys and second chains and thereby providing essentially equal and opposing forces, system 200 may reduce or cancel vibrations that may be caused by unbalanced forces or loads. This for example strengthens system 200, allowing it to withstand greater overall stresses. It will be understood that multiple systems 200 may be added in series to meet greater power or load requirements.

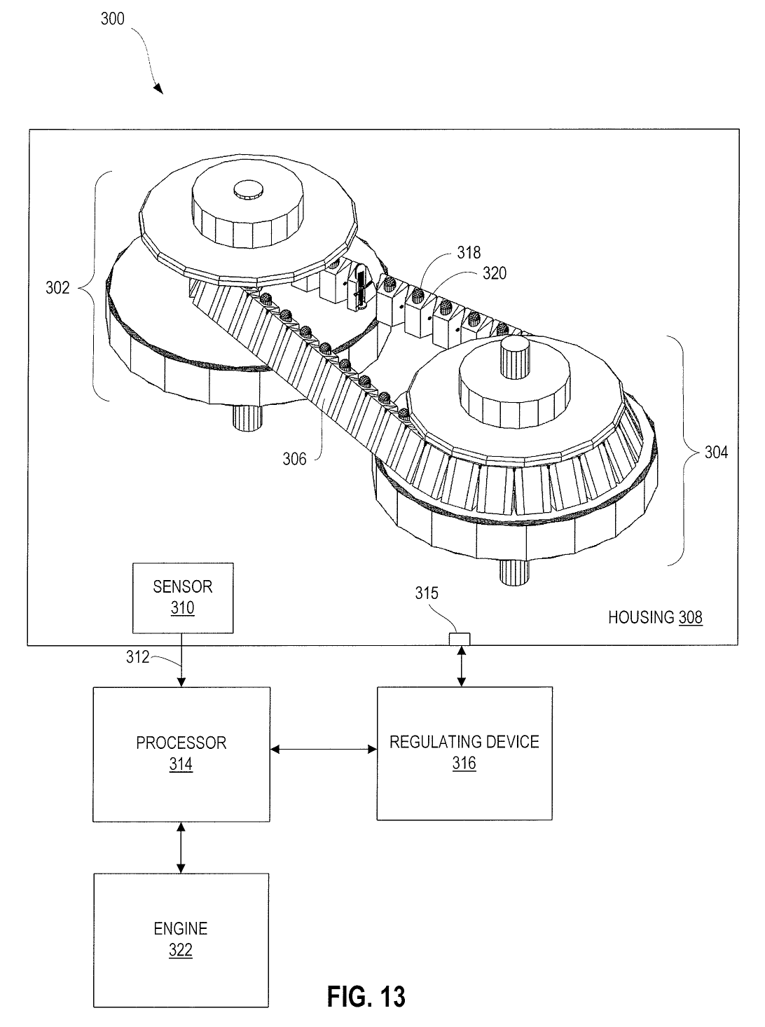

FIG. 13 schematically illustrates a vacuum-generating dynamic transmission system 300, wherein pulleys 302 and 304 and a chain 306 are enclosed in a pressurizable housing 308. In this embodiment, pulleys 302, 304 and chain 310 may represent pulleys 102, 104 and chain 120, respectively. At least one sensor 310 senses pressure within housing 310. Sensor 310 may be partially or completely enclosed in housing 308, with a link 312 to a processor 314, shown external to housing 308 in FIG. 13. Link 312 may be a wire or cable. Alternately, sensor 310 may transmit wireless signals indicative of sensed pressure along a virtual or wireless link 312 to processor 314. Processor 314 communicates (wired or wirelessly) with a pressure regulating device 316 (such as a pump), in communication with housing 308 via a connection point 315, to increase or decrease pressure within housing 308, e.g., to enhance the chain-to-link vacuum created by one or more vacuum-generating devices 318 within links 320 of chain 306. See e.g., description of chain links 120 and vacuum-generating device 134, with respect to FIGS. 9-11E, above.

In one embodiment, processor 314 is communicatively connected (e.g., wirelessly or via a wire or cable) with an engine 322 that provides mechanical power for system 300 (for ease of illustration, connection between system 300 and engine 322 is not shown). Processor 314 receives signals from engine 322 pertaining, for example, to mechanical power requirements when starting an automobile powered by engine 322. Processor 314 may calculate optimal pressure conditions for housing 308 based upon power requirement information of engine 322 and compare the optimal pressure conditions with signals from sensor 310. Processor 314 then activates pressure regulating device 316 to adjust pressure within housing 308 to achieve the optimal conditions. In one embodiment, upon initiating forward or backward movement of the aforementioned automobile, processor 314 acts via device 316 to increase pressure within housing 308, to enhance the vacuum-generating, anti-skid properties of chain 306 and provide an essentially infinite number of gear ratios even under high stress conditions.

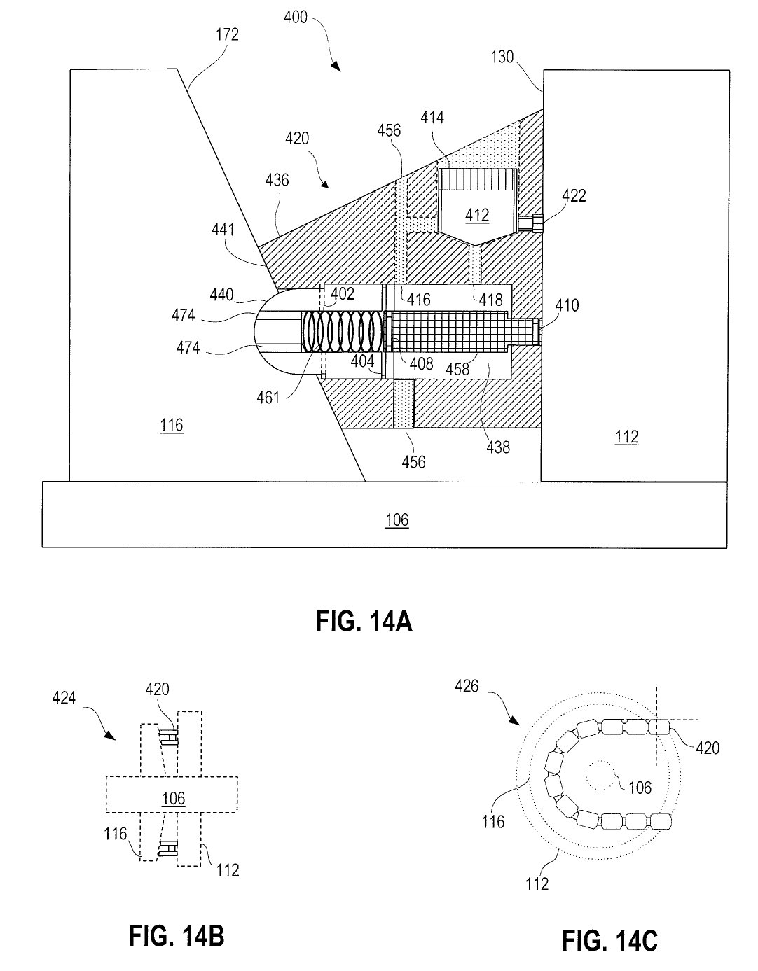

FIG. 14A is a side, schematic view of a vacuum generating dynamic transmission system 400. System 400 employs cylindrical and conical semipulleys 112, 116 on axle 106, described above with respect to systems 100-300. System 400 includes components similar to those described with respect to systems 100-300. For ease of understanding, components of system 400 that are similar to previously described components are given similar reference numbers. For example, a link described with respect to system 400 is denoted as link 420, to comport with the numbering used to identify the link 120 of system 100.

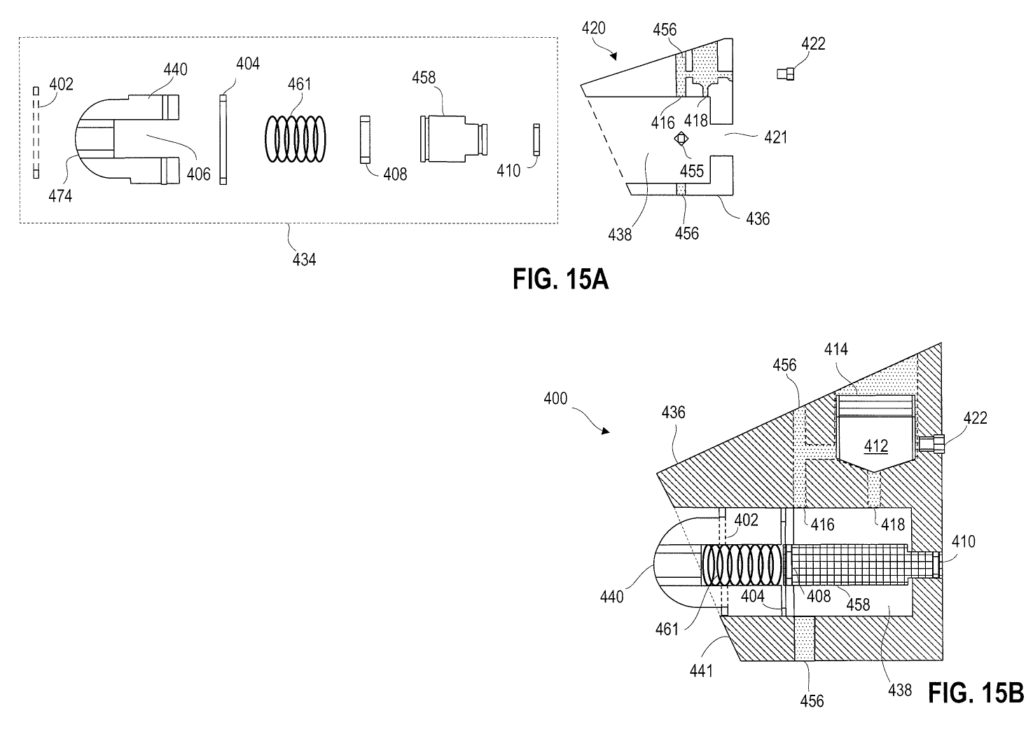

Returning to system 400, a link 420 movably fits between semipulleys 112, 116 as described above with respect to motion and fit of link 120. Link 420 has a link body 436 with a central channel 438, for accommodating components of a vacuum-generating device 434 (detailed in FIG. 15A) and for facilitating pressurization within link 420. For purposes of the following discussion, FIG. 14A is best viewed with schematic side-view FIGS. 15A and 15B, which show additional detail of link 420 and vacuum generating device 434. As shown in FIG. 15A, vacuum generating device 434 (components shown bounded by a dotted line) includes an inductor 440. Inductor 440 fits with channel 138 such that inductor protrudes from an inductor face 441 of chain link 420 (see FIG. 15B). A first safety ring 402 and a second safety ring 404 support inductor 440 within channel 438.

As also shown in FIG. 15A, inductor 440 itself includes a central channel 406, for accommodating an abductor 458 and a spring 461. As link 420 rotates between pulleys (e.g., as part of a chain such as chain 110, FIG. 6), inductor 440 is pressed inward and over abductor 458, for example, via contact with inner face 172 of conical semipulley 116. Spring 461 compresses with inward motion of inductor 440, and expands to push inductor 440 outward and at least partially off of abductor 458 when inward pressure is no longer applied to inductor 440. A third safety ring 408 and a third safety ring 410 support abductor 458 within central channel 438 and/or central chamber 406 of inductor 440. In addition to supporting inductor 440 and abductor 458, rings 402, 404, 408 and 410 may improve pressure ratios of inductor 440 and abductor 458.

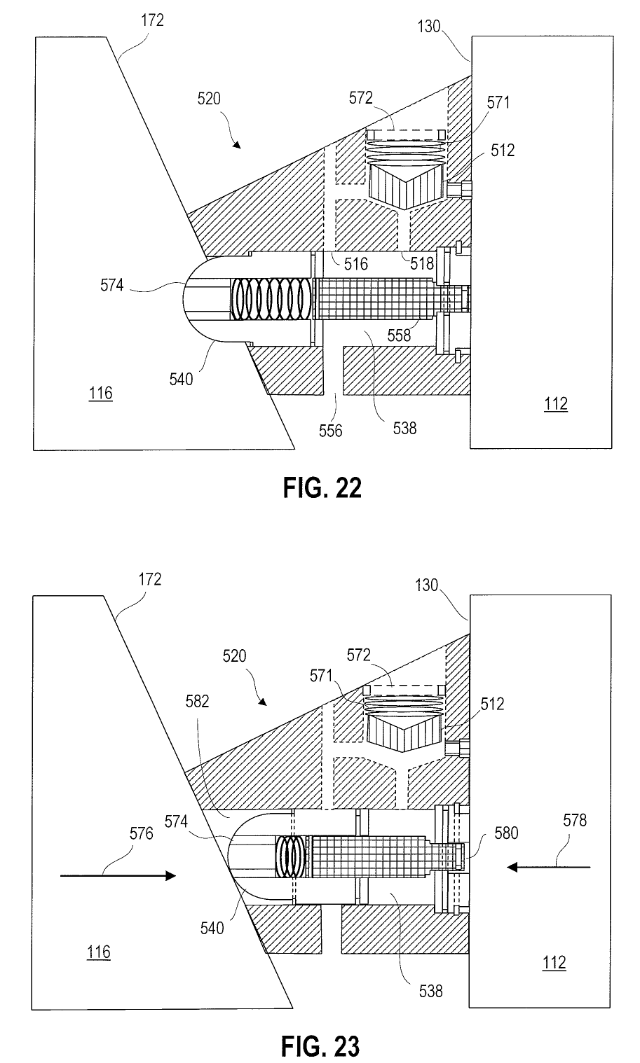

Link body 436 includes at least one conduit 456 for facilitating pneumatic communication between the outside and the inside (e.g., central channel 438) of link 420. Sufficient inward movement of inductor 440 shuts conduit 456 as inductor 440 blocks conduit 456 from within central channel 438. This creates a pressurized chamber within vacuum-generating device 434. Conduit 456 is for example closed as conical semipulley 116 pushes inductor 440 into link body 136, during rotation of a chain including link 420 around a pulley including conical semipulley 116. Conduit 456 is sized and shaped to accommodate a flux valve 412 and optional safety screw 414 for securing flux valve 412 in place. Conduit 456 likewise opens into central chamber 438 via sub channels 416 and 418. Flux valve 412 is for example a one-way pressure release valve that regulates pressure from inductor 440 towards abductor 458, without requiring modifications to the structure of link 420. Flux valve 412 may be fixed (as shown in FIG. 14A) or variable (as described below with respect to FIG. 22). Flux valve 412 offers flexibility in managing pressure created within chain link 120. For example, the valve may be set at a fixed position that creates a release channel for relieving pressure within central channel 438 at a ratio established by the dimensions of the release channel, set by flux valve 412. In one aspect, when inductor 440 is pushed inward, to block conduit sub channel 416, excess pressure within central channel 438 may still be relieved via one-way pneumatic flow through flux valve 412, between channel 438 and the environment external to link 420 (e.g., through sub channel 418 and conduit 456). A screw 422 or other fastener, such as a plug, holds flux valve 412 in place within conduit 456. A channel 455 through link body 436 (schematically shown in FIG. 15A) accommodates a plug, screw or other fastener for securing vacuum generating device 434 in place within central channel 138.

As inductor 440 is pushed inward, available space within central channel 438 is reduced and conduit 456 is closed, thus pressurizing central chamber 438. Central chamber 438 for example has a fixed volume. Movement of inductor 440 within link 420 (e.g., in central chamber 438) increases pressure as the volume of air within central channel 438 is compressed into a smaller area. Increased pressure pulls abductor 458 inward. Release holes 474 permit escape of pressure from central channel 438 to facilitate inward motion of abductor 158. Release holes 474 may likewise provide conduits for air to re-enter central channel 438 as a chain containing link 420 moves out of a pulley and contact between link 420 and the pulley decreases. Air is for example expelled through release holes 474 as link 420 contacts cylindrical semipulley 112, to equalize pressure in different areas of central channel 438 around inductor 420 and abductor 458. Air sucked in through release holes 474 as link 420 breaks contact with semipulley 112. Release holes 474 for example prevent select areas of channel 438 from becoming over pressurized and counteracting pressure created within other areas of channel 438 (see description of pressurization of areas 139A, 139B, with respect to FIG. 10). Release holes 474 thus prevent pressure within chain link 420 from counteracting a vacuum effect between chain link 420 and semipulley 112. As described above, flux valve 412 likewise prevents over pressurization of central channel 438, which might damage internal components of link 120, or create a bleed between pressurized central channel 438 and areas of vacuum (see, e.g., above description of areas 139A, 139B and chambers 178, with respect to FIGS. 10-11E).

Inward motion of abductor 458 creates a vacuum between link 420 and inner face 130 of cylindrical semipulley 112 proximate abductor 458, e.g., at area 421 of link 120 (see FIG. 15A). Vacuum at area 421 for example creates a virtual crown or pinion, securing chain link 420 along any diameter of pulley 102 as it rotates (e.g., at any available position on semipulley 112. See description of FIGS. 3A and 3B, above; see also description of FIGS. 11A-E, above). Vacuum-generating device 434 thereby prevents sliding or skidding, regardless of rotational diameter. As noted above, the rotational diameter is determined by motion of conical semipulley 116 in and out along axle 106 (or semipulley 118 along axle 108). Through their motion, conical semipulleys 116, 118 may thereby determine diametric position of rotation of chain 110, maintain fixed chain tension and set vacuum-generating device 434.

FIGS. 14B and 14C show side and top position diagrams 424 and 426, respectively. Diagrams 424 and 426 schematically illustrate position of link 420 as depicted in FIG. 14A, as link 420 rotates (as a chain component) around axle 106 and between semipulleys 112 and 116.

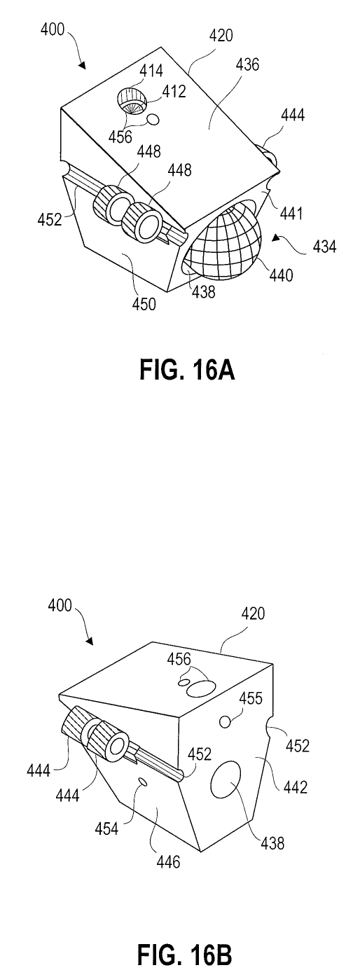

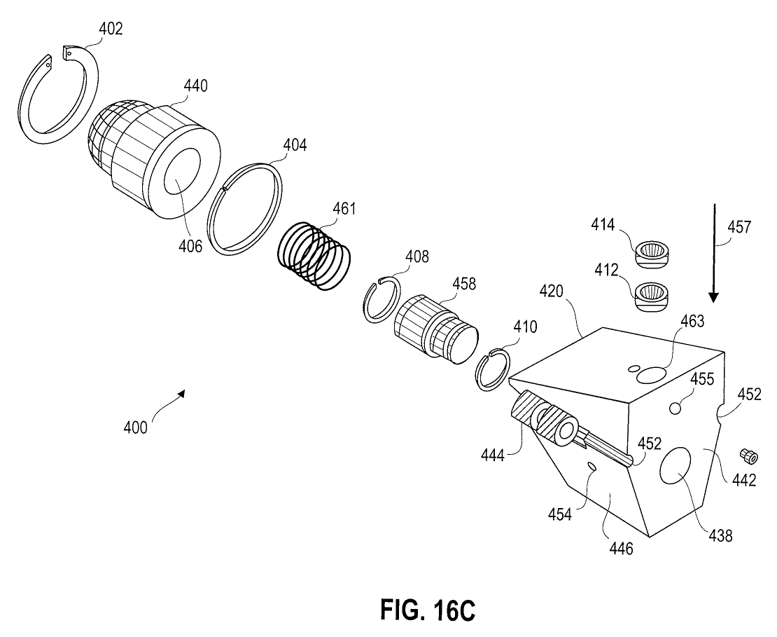

FIGS. 16A and 16B are front (inductor-side) and rear (abductor-side) perspective views of link 420. Link 420 has an inductor face 441, an abductor face 442 and linking faces 146 and 150. FIG. 16A shows inductor 440 protruding from central channel 438 through inductor face 441. Flux valve 412 and safety screw 414 are visible within conduit 456 through the top of link 420. Pin channels 452 disposed with joining sides 446 (see FIG. 16B) and 450 of link body 436 facilitate securing one link 420 to another link. A pair of lateral rollers 448 fitted to pin channel 452 for example fit with a pair of lateral rollers 444 on joining side 446 of a second link 420 (See FIG. 16B). A linking pin (not shown) though rollers 444, 448 may be used to join one link 420 to a second link (e.g., link 120 or a second link 420). Optionally, pin channel 452 along joining side 446 includes one lateral roller 444 that fits with (i.e., between) lateral rollers 448 on joining side 450 of the second link. It will be appreciated that the number, position and fit of rollers on joining sides 446 and 450 may be altered, as a matter of design preference.

Turning to FIG. 16B, channel 454 may be used to secure components of vacuum-generating device 134 within central channel 138, e.g., using a screw, cotter pin or other fastener. A channel 455 through abductor face 442 into conduit 456 fits screw 422 or another fastener, to secure flux valve 412 in place.

FIG. 16C is an exploded, abductor-side perspective view of link 420 and vacuum generating device 434, separated into its components. Flux valve 412 and safety screw 414 are likewise shown exterior to link 420. Flux valve 412 is lowered into conduit 456, as indicated by arrow 457, and safety screw 414 is screwed into place above flux valve 414. A valve chamber 463 of conduit 456 for example includes a threaded upper portion, for engaging with safety screw 414.

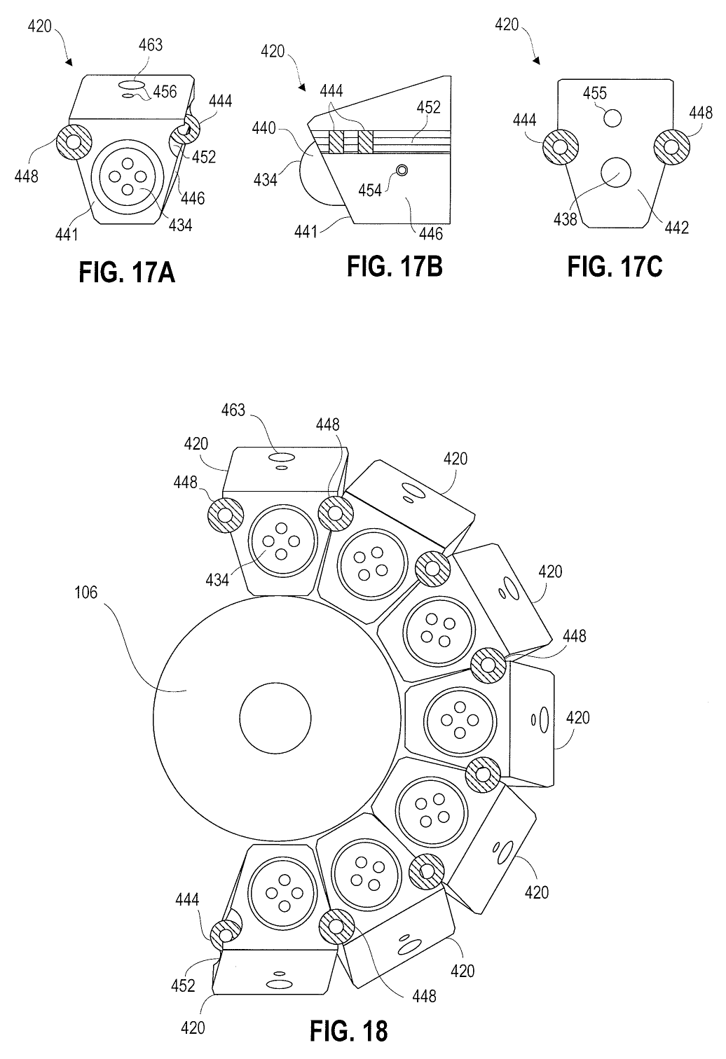

FIGS. 17A-17C are simplified inductor-side, joining side and abductor side views of link 420 (respectively). FIGS. 17A and 17B show vacuum generating device 434, in particular, inductor 440, extending from link 420 through channel 138 (not labeled) in inductor face 141. As shown in FIG. 17B, channel 454 may open through side joining side 446. Optionally, channel 454 may penetrate link 420, from joining side 446 to joining side 450, and fasteners may be introduced into channel 454 from either or both of joining sides 446, 450, to secure components of vacuum generating device 434 in place. FIG. 18 schematically illustrates a plurality of joined chain links 420, rotating about axle 106. Rollers 444 of one link 420 join with rollers 448 of an adjacent link 420, e.g., via a joining pin.

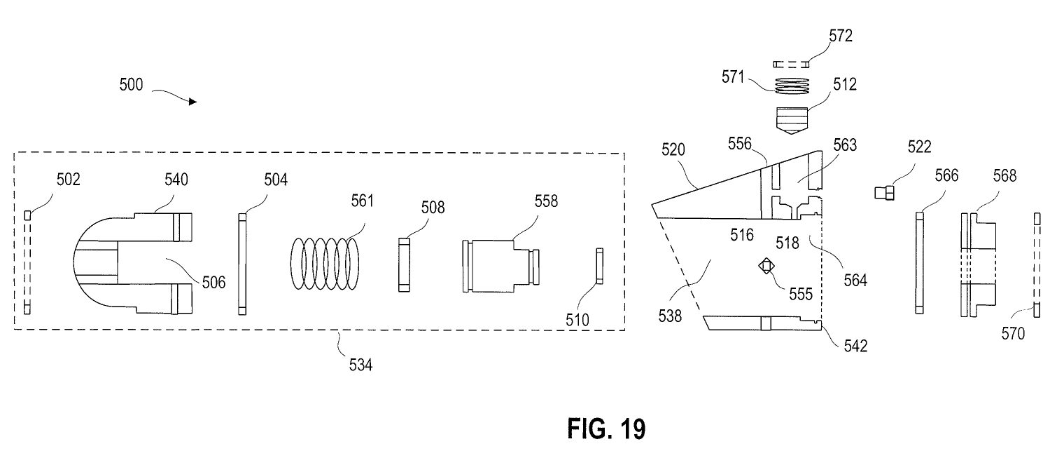

FIG. 19 is a schematic side view depicting components of a vacuum generating dynamic transmission system 500. System 500 includes a number of components that are similar to those described with respect to systems 100-400, above. For clarity, such components are denoted with reference numbers similar to those used to describe like components of systems 100-400. For example, like systems 100 and 400, system 500 employs an inductor. Hence, the inductor of system 500 is given reference number 540, in observance of reference numbers 140 and 440 used to denote the respective inductors of systems 100 and 400.

System 500 includes a chain link 520 having a conduit 556 for regulating pressure between the environment external to link 520 and a central channel 538. Conduit 556 for example opens into channel 538 via two sub channels, 516 and 518, and includes a valve chamber 563, for accommodating a flux valve 512 and supporting structures, described herein below.

Channel 538 accommodates a vacuum generating device 534 having an inductor 540 and an abductor 558. Safety rings 502 and 504 secure abductor 540 within central channel 538, and may facilitate pressure regulation within channel 538.

Inductor 540 has a central channel 506, for accommodating abductor 558. A spring 561 fits within channel 506, between inductor 540 and abductor 558. Spring 561 compresses with inward motion of inductor 540, e.g., as inductor 540 is pushed within link 520 and at least partially over (e.g., around) abductor 558, due to contact with a semipulley, as described above with respect to systems 100 and 400 (see, e.g., FIGS. 10 and 15). When pressure upon inductor 540 is reduced or ceased, spring 561 expands to return inductor 540 to its original “ready” position. Two safety rings 508 and 510 facilitate in securing abductor 558 within inductor 540 and central channel 538, and may also enhance pressure regulation within channel 538, for example by providing a close fit between abductor 558 and inner walls of inductor 540 or channel 538.

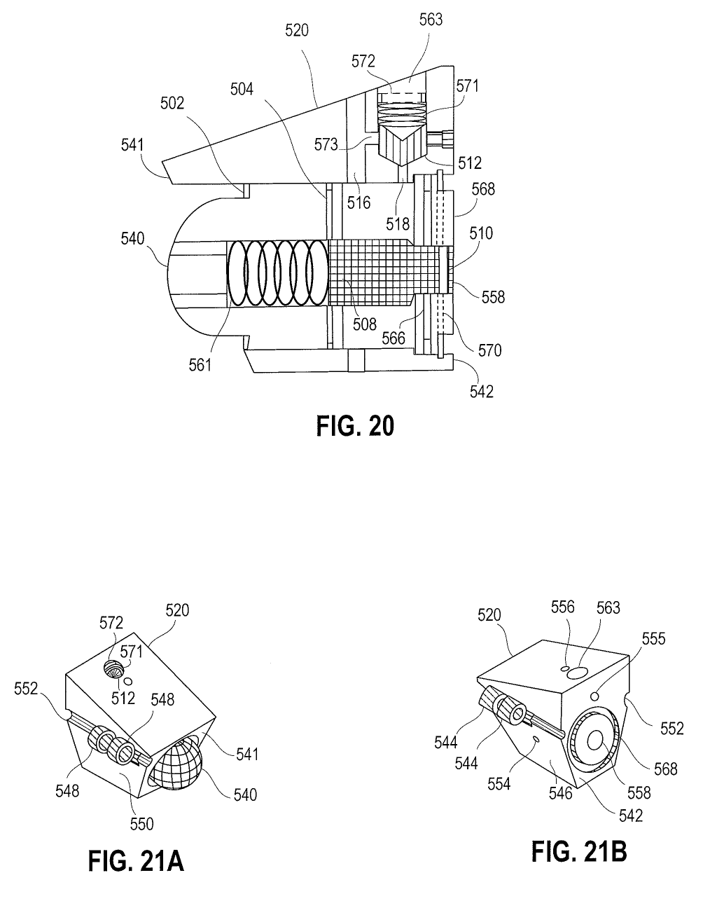

As shown in FIG. 19, channel 538 widens into a support seal antechamber 564 at an abductor face 542. Antechamber 564 accommodates a support ring 566, a support seal 568 and a safety ring 570, which are fitted within antechamber 564 as illustrated in FIG. 20 (described below). Support ring 566 supports seal 568 within antechamber 564. Seal 568 prevents pressure loss from channel 538, and safety ring 570 secures seal 568 within antechamber 564 and may further aid in preventing pressure loss by providing a tight seal with link 520 within antechamber 564. Flux valve 512 is set in valve chamber 563 with a spring 571 and a safety ring 572. Safety ring 572 secures flux valve 512 and spring 571 within valve chamber 563. Flux valve 512 may be further secured in place with screw 522.

FIG. 20 shows vacuum generating device 534 assembled within link 520. Inductor 540 protrudes from inductor face 541. Abductor 558 and support seal 568 are approximately flush with abductor face 542. Valve 512, spring 571 and safety ring 572 are placed within valve chamber 563 and moveably secured in place with screw522. Spring 571 allows flux valve 512 to flex within valve chamber 563, for example when pressure within central channel 538 and sub channel 518 force flux valve 512 to move or bow upward in valve chamber 563. Sufficient upward motion of flux valve 512 in valve chamber 563 un-blocks a sub channel 573, permitting air exchange between the environment external to link 520 and central channel 538, via conduit 556 and sub channel 518. Once upward pressure on valve 512 (e.g., pressure within central channel 538) drops below a downward pressure exerted by spring 571, spring 571 decompresses and returns flux valve 512 to its original position, blocking sub channel 573. Hence, flux valve 512 aids in pressure regulation within channel 538 and may prevent over-pressurization that might potentially damage or break components of vacuum generating device 134 within chain link 120. Prevention of over-pressurization may also protect against a bleed between central channel 538 and a vacuum area 580 (described below with respect to FIG. 22), which would counteract a desired vacuum effect.

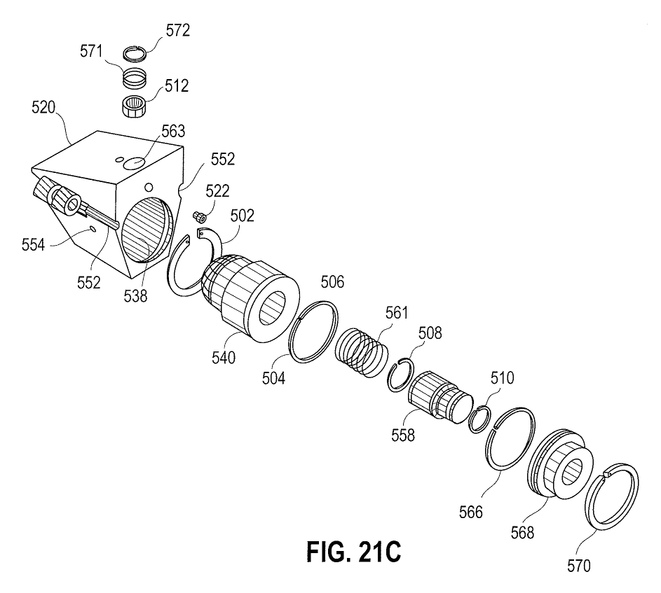

FIGS. 21A and 21B are inductor-side and abductor-side perspective views of link 520. FIG. 21A shows inductor 540 protruding from central channel 538 through inductor face 541. Flux valve 512, spring 571 and safety ring 572 are roughly depicted within valve chamber 563 (shown empty in FIG. 21B). A pin channel 552 in a joining side 550 partially encloses rollers 548. Rollers 548 join with one or more rollers 544 on joining side 546 (see FIG. 16B) of link 520. Rollers 544 of one link 520 are fitted with rollers 548 of another link 520, and a linking pin or other fastener through rollers 544 and 548 rotatably joins the two links 520 together. The number and location of rollers 544 and 548 may vary as a matter of design preference, so long as rollers 544 of one link fit with rollers 548 of a second link 520.

FIG. 21B shows a channel 555 through abductor face 542, for accommodating screw 522 to moveably secure flux valve 512 within valve chamber 563. An end 575 of abductor 558 is approximately flush with abductor face 552. FIG. 21C is an exploded perspective view of link 520, vacuum generating apparatus 534 and associated components.

FIGS. 22 and 23 are simplified cross-sectional diagrams of link 520 between cylindrical and conical semipulleys 112, 116, showing movement of inductor 540 and abductor 558 due to pressure changes within central channel 538. FIGS. 22 and 23 are best viewed together with the following description. For ease of illustration, not all components of link 520 and vacuum generating device 534 are shown.

In particular, FIG. 22 shows link 520 before inductor 540 meets with inner face 172 of conical semipulley 116 (i.e., semipulley 116 is behind inductor 540, as indicated in FIG. 22. As link 520 moves further between cylindrical and conical semipulleys 112, 116, inner face 172 of conical semipulley 116 pushes inductor 540 into central channel 538, in the direction of motion arrow 576 (FIG. 23). Inward movement of inductor 540 blocks conduit 516 and conduit 556 (labeled in FIG. 22) and reduces volume of central channel 538. The reduction in volume increases pressure within central channel 538. Pressure distributions within channel 538 draw abductor 558 inward, in the direction of motion arrow 578 (FIG. 23), creating a vacuum between link 520 and inner face 130 of cylindrical semipulley 112, at area 580. See, e.g., description of pressure differentials in chambers 138A, 138B, with respect to FIGS. 10 and 11.

Release holes 574 allow pneumatic transfer between reduced-area central channel 538 and a region 582 around pressed-in inductor 540 within central channel 538, for example to avoid over-pressurization that might jeopardize the vacuum seal between link 520 and cylindrical semipulley 112. Likewise, flux valve 512 facilitates pressure release from reduced-area central channel 538. In one embodiment, when pressure within reduced-area central channel 538 increases to a valve threshold level, flux valve 512 opens and pressure within reduced-area central channel 538 is reduced via pneumatic communication with the external environs, until channel 538 pressure falls below the threshold level of flux valve 512. Valve 512 then closes and pneumatic communication between reduced-area central channel 538 and the external environment via conduit 556 stops. In another aspect, when pressure within reduced-area central channel 538 exceeds a level of downward pressure exerted by spring 571, valve 512 moves or bows upward and compresses spring 571, thus un-blocking sub channel 573, and allowing pressure exchange between the external environment and central channel 538. If channel 538 pressure falls below the downward pressure exerted by spring 571, the spring decompresses to un-bow or push valve 512 downward, blocking sub channel 573. Safety ring 572 prevents spring 571 from being pushed upward and out of place, for example due to upward pressure exerted by valve 512.

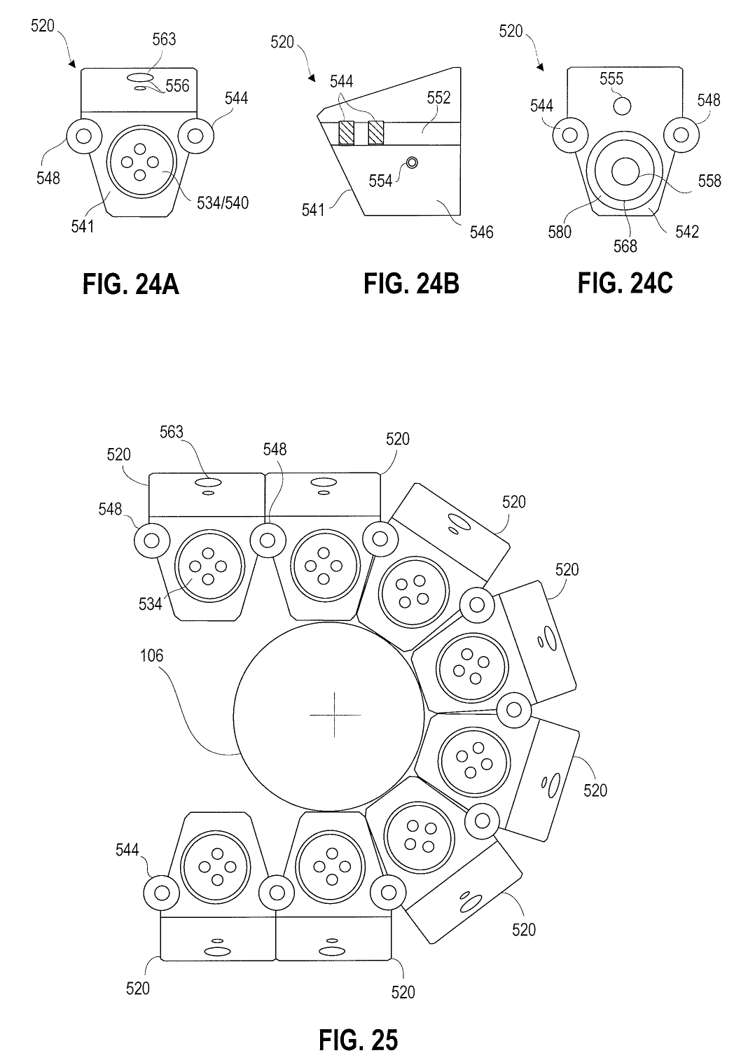

FIGS. 24A-24C are simplified schematic diagrams showing top and inductor side, joining side and abductor side views of link 520 (respectively). FIGS. 24A shows link 520 with inductor 540 pressed inward, thus inductor 540 is not visible in FIG. 54B. As shown in FIG. 24B, channel 554 opens through joining side 446. Optionally, channel 554 may penetrate link 520, from joining side 546 to joining side 550, and fasteners may be introduced into channel 554 from either or both of joining sides 546, 550, to secure components of vacuum generating device 534 in place. As shown in FIG. 24C, abductor 538 is recessed inward, e.g., due to pressure changes within central channel (not labeled), creating vacuum area 580. Support seal 568 is visible around inductor 558 in inductor face 541.

FIG. 25 schematically illustrates a plurality of joined chain links 520, rotating about axle 106. Rollers 544 of one link 520 join with rollers 548 of an adjacent link 520, e.g., via a joining pin, as described above with respect to FIG. 18.

Changes may be made in the above systems and structures without departing from the scope thereof. For example, the vacuum generating dynamic transmission system disclosed herein may be servo-assisted, or configured for connection with external devices to regulate pressure of the system and/or to regulate pressure within/around the chains. Likewise, movement of the above disclosed components may be assisted mechanically, electronically, pneumatically or hydraulically, as a matter of design preference. For example, the above-described vacuum generating dynamic transmission system may link with mechanical, electronic, pneumatic or hydraulic devices for ssisting movement of one or more components of the system. Likewise, lubricants may be employed to enhance component movement. It should thus be noted that the matter contained in the above description and/or shown in the accompanying drawings should be interpreted as illustrative and not in a limiting sense. The following claims are intended to cover generic and specific features described herein, as well as all statements of the scope of the present system and structures, which, as a matter of language, might be said to fall therebetween.

1. A vacuum-generating dynamic transmission system, comprising:
a first pulley fixed for rotation about a first axle and a second pulley fixed for rotation about a second axle; and
a chain for rotation around the axles and the pulleys, the chain having a plurality of links, one or more links of said plurality having a vacuum-generating device that pressurizes the chain to at least one of the pulleys.

2. The system of claim 1, each of the links forming a trapezoidal shape.

3. The system of claim 1, each of said one or more links forming a central channel and each of said vacuum generating devices comprising an inductor and an abductor that respond to contact with the pulleys to provide pressurization within the channel.

4. The system of claim 1, each pulley comprising a cylindrical semipulley and at least one conical semipulley, the conical semipulley movable along its axle to vary a rotational diameter of the pulley.

5. The system of claim 4, wherein each of said one or more links forms a central channel to permit pressurization of the chain, and wherein said vacuum generating device comprises:
a movable inductor protruding from the channel on a first side of the link, the first side of the link contacting the conical semipulley as the chain rotates through the pulley;
a movable abductor within the channel and proximate a second side of the link, the second side of the link contacting the cylindrical semipulley as the chain rotates through the pulley; and
a conduit from the central channel to an environment external to the link.

6. The system of claim 5, wherein contact with the conical semipulley pushes the inductor into the link such that the inductor blocks the conduit to create at least one pressurized chamber within the central channel.

7. The system of claim 6, the link comprising:
a subchannel for releasing excess pressure from the central channel to an environment external to the link, when the inductor blocks the conduit; and
a flux valve disposed with a valve chamber, the flux valve regulating release of pressure through the subchannel.

8. The system of claim 6, wherein pressure within the chamber pulls the abductor inward and away from the second side of the link, to create a vacuum between the cylindrical semipulley and the link.

9. The system of claim 8, the vacuum creating a virtual pinion for securing the chain to the cylindrical semipulley.

10. The system of claim 4, wherein motion of the conical semipulleys provides a substantially infinite number of gear ratios between a smallest and a widest of the rotational diameters.

11. The system of claim 4, the pulleys comprising opposing pulleys, wherein the rotational diameter of one pulley varies inversely to the rotational diameter of the opposing pulley, to maintain one or both of chain tension and length.

12. The system of claim 8, further comprising one or more springs for returning the inductor and the abductor to a ready position, when rotation of the chain around the pulley pulls the link out of contact with the semipulleys.

13. The system of claim 8, further comprising a housing for the pulleys and the chain, the housing having a connection point for connecting to an external device for adjusting pressure within the housing.

14. The system of claim 13, wherein adjusting pressure within the housing adjusts one or both of:
pressure within the central channel, and
the vacuum between the cylindrical semipulley and the link.

15. The system of claim 13, wherein adjusting pressure comprises adjusting pressure according to mechanical power requirements on a motor in communication with the system.

16. A method for forcing a drive chain against pulleys of a continuously variable transmission, comprising:
in response to contact between the pulleys and chain, moving an inductor and abductor within one or more chain links of the chain to create a vacuum that forces the chain to the pulleys.

17. A method for vacuum-generating, dynamic transmission, comprising:
providing a system of pulleys, each pulley of the system having a conical semipulley and a cylindrical semipulley joined by an axle;
providing a chain for rotation around the pulleys, the chain having at least one vacuum-generating link for forming a vacuum seal with the cylindrical semipulleys when the link rotates through the pulleys;
moving at least a first conical semipulley along its respective axle in a first direction and by a first distance, to vary the rotational diameter of the chain;
moving a second conical semipulley along its respective axle by the first distance, in a second direction opposite the first direction, to maintain tension of the chain.

18. The method of claim 17, wherein providing a chain comprises:
providing a chain with trapezoidal links;
preparing a central channel through at least one of the trapezoidal links;
preparing a conduit from the central channel through the trapezoidal link, to an environment external to the trapezoidal link;
fitting a movable inductor within and slightly protruding from the channel, such that the inductor may be pressed into the channel; and
fitting an abductor within the channel, opposite the inductor.

19. The method of claim 18, further comprising forming a vacuum seal between the link and the pulley.

20. The method of claim 19, wherein forming a vacuum seal comprises pressing the inductor into the central channel via contact with a conical semipulley, to block the conduit; wherein blocking the central channel creates a pressurized chamber within the link, the pressurized chamber pulling the abductor inward to create a vacuum seal between the abductor and the cylindrical semipulley.

21. The method of claim 14, wherein movement of the conical semipulleys along the axles provides a continuum of substantially infinitely variable gear ratios, the vacuum-generating link securing the chain to the pulley to prevent slipping at any gear ratio.

22. Vacuum generating chain for a continuously variable transmission, comprising:
a plurality of chain links, one or more of the chain links including at least one vacuum-generating device that pressurizes the chain to at least one pulley of the continuously variable transmission.

23. The chain of claim 22, the one or more links comprising a central channel within the link; each vacuum-generating device comprising:
an moveable inductor fitted with the central channel and protruding from the link; and
a moveable abductor fitted within the central channel, opposite the inductor.

24. The chain of claim 23, further comprising a conduit extending from the central channel to an outer face of the link, wherein pressure upon the inductor protruding from the link forces the inductor into the central channel and closes the conduit to pressurize a chamber within the central channel, and wherein pressure within the chamber draws the abductor inward to create a vacuum between the link and a pulley proximate the link, opposite the inductor.

25. A vacuum-generating dynamic transmission system, comprising:
a housing;
at least two pulleys fixed upon respective axles and disposed within the housing;
a vacuum-generating chain for rotation around the axles and the pulleys, the chain having trapezoidal shaped links, one or more of the links comprising a vacuum generating device;
at least one pressure sensor for sensing pressure within the housing; and
a processor in communication with the pressure sensor and a pressure regulating device,
wherein the processor engages the pressure regulating device to adjust pressure within the housing, responsive to pressure information from the pressure sensor and power requirements of an engine in communication with the vacuum-generating transmission system.
